(19) United States
(12) Patent Application Publication
(10) Pub. No.: US 2002/0044689 A1
(43) Pub. Date: Apr. 18, 2002

(54) Apparatus and method for global and local feature extraction from digital images

(76) Inventors: Alex Roustaei, La Jolla, CA (US); Kevin Xiao, Ottawa (CA); Wenji Xia, Nepean (CA)

Correspondence Address: MORRISON & FOERSTER LLP, 3811 VALLEY CENTRE DRIVE, SUITE 500, SAN DIEGO, CA, 92130-2332, US

(21) Appl. No.: 09/801,110

(22) Filed: Mar. 5, 2001

Related U.S. Application Data
(63) Continuation-in-part of application No. 09/268,222, filed on Mar. 15, 1999.
(63) Continuation-in-part of application No. 09/208,284, filed on Dec. 8, 1998.
(63) Continuation-in-part of application No. 09/703,501, filed on Oct. 31, 2000.
(63) Continuation-in-part of application No. 08/690,752, filed on Aug. 1, 1996.
(63) Continuation-in-part of application No. 08/569,728, filed on Dec. 8, 1995.
(63) Continuation-in-part of application No. 08/363,985, filed on Dec. 27, 1994, now abandoned.
(63) Continuation-in-part of application No. 08/059,322, filed on May 7, 1993, now abandoned.
(63) Continuation-in-part of application No. 07/956,646, filed on Oct. 2, 1992.
(63) Continuation-in-part of application No. 08/410,509, filed on Mar. 24, 1995.
Application No. 09/208,284 is a continuation-in-part of application No. 08/444,387, filed on May 19, 1995.
(63) Continuation-in-part of application No. 08/329,257, filed on Oct. 26, 1994.
(60) Provisional application No. 60/247,550, filed on Nov. 9, 2000.

(51) Int. Cl. G06K 9/48

(52) U.S. Cl. 382/199; 382/206

(57) ABSTRACT

An optical imaging device and method which utilizes global feature extraction and local feature extraction to locate, identify and decode optical codes found within a captured image is disclosed. A global feature extraction unit first processes low-resolution image data to locate regions of interest that potentially contain the code(s). If no regions of interest are identified by processing the low-resolution image data, the global feature extraction unit then processes higher-resolution image data to locate the regions of interest. Any regions of interest located by the global feature extraction unit are then transferred to a local feature extraction unit which identifies and decodes a code found within a region of interest. Both the global feature extraction unit and the local feature extraction unit can begin processing data representative of portions of the image being captured before all of the data representative of the complete image is transferred to the respective unit.

### RELATED APPLICATIONS

Priority is claimed from Provisional Application Ser. No. 60/247,550, filed Nov. 9, 2000, entitled, “Method and System for Global and Local Extraction in Digital Imaging” which is incorporated herein by reference in its entirety.

This application is a continuation-in-part of U.S. application Ser. No. 09/268,222, entitled “Optical Scanner and Image Reader for Reading Images and Decoding Optical Information Including One and Two Dimensional Symbologies at Variable Depth of Field,” filed Jul. 28, 2000, which is incorporated herein by reference in its entirety.

This application is also a continuation-in-part of U.S. application Ser. No. 09/208,284, entitled “Imaging System and Method,” filed Dec. 8, 1998, which is a continuation-in-part of U.S. application Ser. No. 09/073,501, filed May 5, 1998, which is a continuation-in-part of U.S. application Ser. No. 08/690,752, filed Aug. 1, 1996, which is a continuation-in-part of U.S. application Ser. No. 08/569,728, filed Dec. 8, 1995, which is a continuation-in-part of U.S. application Ser. No. 08/363,985, filed Dec. 27, 1994, which is a continuation-in-part of U.S. application Ser. No. 08/059,322, filed May 7, 1993, which is a continuation-in-part of U.S. application Ser. No. 07/956,646, filed Oct. 2, 1992, now issued as U.S. Pat. No. 5,349,172, which is a continuation-in-part of U.S. application Ser. No. 08/410,509, filed Mar. 24, 1995, which is a re-issue application of U.S. application Ser. No. 07/843,266, filed Feb. 27, 1992, now issued as U.S. Pat. No. 5,291,009. U.S. application Ser. No. 09/208,284 is also a continuation-in-part of U.S. application Ser. No. 08/137,426, filed Oct. 18, 1993, and a continuation-in-part of U.S. application Ser. No. 08/444,387, filed May 19, 1995, which is a continuation-in-part of U.S. application Ser. No. 08/329,257, filed Oct. 26, 1994, all of which are incorporated herein by reference in their entireties.

### FIELD OF THE INVENTION

The invention relates to digital imaging technology and more specifically to a method and system for rapidly identifying an area of interest containing machine-readable information within an optical field of view.

### BACKGROUND OF THE INVENTION

Digital imaging technology continues to improve and find widespread acceptance in both consumer and industrial applications. Digital imaging sensors are now commonplace in video movie cameras, security cameras, video teleconference cameras, machine vision cameras and, more recently, hand-held bar code readers. As each application matures, the need for intelligent image processing techniques grows. To date, the large data volume attendant to transmitting a digital image from one location to another could only be accomplished if the two locations were connected by a wired means. Machine vision and imaging-based automatic identification applications required significant computing power to be effective and correspondingly required too much electricity to be useful in portable applications. The trend now in both consumer and industrial markets is toward the use of portable wireless imaging that incorporates automatic identification technology.

Historically, the automatic identification industry has relied on laser technology as the means for reading bar codes. Laser scanners generate a coherent light beam and direct it along a line over the item to be scanned. The reflected intensity of the laser beam is used to extract the information from the bars and spaces of the bar codes that are encountered. Laser scanners are effective in reading linear bar codes such as the U.P.C. code found in retail point-of-sale applications, Code 39, or Interleaved 2 of 5. Laser scanners can also read stacked linear bar codes such as PDF417, Code 49, or Codeablock. Lasers scanners cannot, however, read the more space efficient two-dimensional matrix bar codes such as Data Matrix, MaxiCode, Aztec Code, and Code One. Furthermore, laser scanners cannot read any typed or hand written characters or any other form of non-linear information. Imaging-based scanners, on the other hand, can read all linear bar codes, stacked linear bar codes, two-dimensional matrix bar codes, OCR characters, hand written characters, and also take digital photographs.

Image-based scanners use a solid-state image sensor such as a CCD or a CMOS imager to convert an image scene into a collection of electronic signals. The image signals are processed so that any machine-readable character or bar code found in the field of view can be located in the electronic representation of the image and subsequently interpreted. The ability of image-based readers to capture an electronic image of a two-dimensional area for later processing makes them well suited for decoding all forms of machine-readable data.

Although image based readers are ideal for automatic identification and machine vision applications, there are a number of drawbacks to their use. The quality of the image produced by the image sensor plays a large part in the ease of decoding the optically encoded data. Variations in target illumination cause an optical code to be difficult to detect or reliably decode. The resolution of the sensor is another limiting factor. Typical solid-state image sensors are made up of a number of small, closely spaced photo-detectors. The photo-detectors generate an image signal based on the amount of light shining on them. Each detector captures a small element of the complete picture; the name given to the minimum picture element is a ‘pixel’. The number of pixels that make up an image are a measure of the resolution of the sensor. Generally speaking, the quality of the output image is proportional to the image sensor resolution. High-resolution sensors, however, require a significant amount of processing time to create a high-quality output image. The image signals must be processed to allow the decoding of the optical code. The time required to decode the optical code symbol is determined by the processing time for the reader. As the number of pixels used to represent the image increases, the processing time also increases.

U.S. Pat. No. 4,948,955 (Lee et al) discloses a method for locating a 1D bar code within a document, then processing only the areas in which a bar code is found. Lee teaches a process by which the scanned image is first sub-sampled to reduce the number of pixels that need to be processed. A carefully chosen probe pattern is scanned across the sub-sampled image to detect bar code blocks and their orientation. Once the block is detected, bar code features such as major axis length, centroid location, and area of the block are used to determine the location of the corners of the bar code. This invention requires the full image to be captured before scanning begins. The invention is also limited in that it cannot read or detect 2D bar codes such as Data Matrix or MaxiCode. Furthermore, damaged codes may be overlooked.

U.S. Pat. No. 5,418,862 (Zheng et al) discusses a method for locating a bar code in an image by scanning the image for the ‘quiet zone’ that surrounds a bar code. Once located, only the candidate areas are analyzed to identify the corners of the optical code. This invention requires that a histogram of the grayscale image be calculated before beginning the decode cycle. In order for a histogram to be generated, the entire image must be analyzed before decoding can begin. This scheme has a high decode latency time as the decoder unitry sits idle until the entire image is read out of the sensor.

Yet another method for improving the processing time is disclosed in US Pat. No. 5,343,028 (Figarella et al). In this patent, an image is quickly scanned to try to identify bar code ‘start’ and ‘stop’ patterns. Most 1D bar codes have a known sequence at either end of the symbol that allows a decoder to detect the correct scan direction and identify the code used. Once located, the image area that contains the start and stop patterns is analyzed in detail. The start and stop pattern-locating algorithm does not, however, allow for the identification of certain 2D bar codes like Data Matrix. Furthermore, if the start or stop patterns are damaged, the code will not be detected.

U.S. Pat. No. 5,073,954 (Van Tyne et al) describes a system for locating a particular type of optical code within a field of view. This invention is optimized for the high-speed decoding of variable-height bar codes such as the POSTNET code, used by the US Postal Service. This patent describes a method of counting pixels along a horizontal scan line. A feature of the POSTNET code is used to identify the orientation and location of bar code blocks for fast decoding. The invention of this patent is limited, however, to 1D bar codes of a specific type and is not suitable for use in a general-purpose, 1D and 2D bar code reader.

An image-based code reader is also described in U.S. Pat. No. 5,296,690 (Chandler et al). The reader described by Chandler performs five steps, including capturing the image, detecting bar code locations within the image, determining the orientation of any bar codes, filtering the codes, and scanning the codes to generate decoded data. The reader segments the image field into a number of cells oriented horizontally, vertically, on a rising diagonal, and on a falling diagonal relative to the image boundary. Scan lines running parallel to a cell boundary are used to detect bar code locations by computing a ‘reflectance derivative’ score for each scan line. Closely-spaced light and dark areas, as seen in bar codes, will generate a high score. This arrangement requires that the entire image be stored in memory before processing can begin, and thus suffers from a high latency between image capture and decoding. If high-resolution sensors are used (1 million pixels or more), the time it takes to transfer the image data from the sensor will substantially affect the decode time of this reader.

The present inventor has also disclosed a system for quickly locating bar codes in a field of view. U.S. Pat. No. 5,756,981 (Roustaei et al) discloses a ‘double-taper’ data structure. This algorithm is shown in FIG. 1. A complete grayscale image 21 with an approximate size of 32 kB is input to the process. A low-resolution feature field 22 is generated from the grayscale image by binarizing the grayscale image and down-sampling the image by 100 times. The feature field is then segmented into subfields by grouping areas of dark pixels 23. Each subfield is then analyzed in turn 24. The code is located, and the type of code is detected 25. Vector algebra is used to determine the type of code found within the subfield based on the subfield shape. If the subfield shape indicates a 1D bar code or PDF417 shape, step 261 determines which of these codes is present and passes the code type data to the decoding step 27. If the subfield shape indicates a 2D bar code, step 263 determines which 2D code is present and passes the code type data to the decoding step 27. If the subfield shape is indicative of noise, step 262 causes the decode step to be bypassed. The code type and location is used to identify the area of interest on a full-resolution grayscale image 264 where grayscale processing is executed to sample the bar code elements and decode the symbol 27. Once analyzed, the subfield is marked with a delete label 28 and the next subfield is selected. Once the last subfield has been analyzed, the algorithm is terminated 29. This arrangement, however, requires that the full image be available for analysis before the algorithm can be executed. Furthermore, by sampling the grayscale image 264 and binarizing the bar code 27 after locating the subfield 25, the software must perform a substantial amount of image processing during a decode cycle. This will limit the decode speed of the optical code reader. Additionally, this algorithm does not have the capability of repairing damaged finder patterns.

### SUMMARY OF THE INVENTION

The present invention overcomes many of the shortcomings of the prior art devices by providing an optical imaging and scanning device and method for decoding multiple 1D and 2D optical codes at any orientation, quickly and reliably—even if the code finder pattern or start bars are damaged. The method may be used in conjunction with any type of image capture apparatus that is capable of creating a digital representation of a spatial area.

In one embodiment of the invention, an optical scanner captures and successfully processes an image containing one or more optical codes by first converting the image into a binary data image (i.e., each pixel is either black or white -no greyscale levels). Thereafter, a global feature extraction unit executes the following steps: create a low-resolution copy of the binary image; identify areas of interest within the low-resolution image that may contain optical codes; reject image areas that do not match an expected shape; identify the general code type based on the shape of the area of interest; and define bounding boxes around each area of interest. The optical scanner also includes a subsequent local feature extraction unit to execute the following steps: transfer the bounding box coordinates to the high-resolution image; analyze within each bounding box for the boundary of an optical code; trace the contour and identify or imply the corners of the optical code; locate one or more fragments of the finder pattern to determine the orientation of the optical code; select a pixel scanning method based on the shape of the optical code block; and sample the bars or features within the code to create a cleaned optical code suitable for decoding.

In another embodiment, the binary image is further converted into a “run offset encoded” image which is then subsequently processed by the global and local feature extraction units as described above.

In a further embodiment, if during the global extraction stage the area of interest is too large (e.g., larger than a predetermined geometric area), the global extraction unit processes the high-resolution image to identify areas of interest that may contain optical codes; reject image areas that do not match an expected shape; identify the general code type based on the shape of the area of interest; and define bounding boxes around each area of interest. Thereafter, the local feature extraction unit analyzes the area within each bounding box as described above.

In another embodiment, the local feature extraction may be performed on color, grayscale, binary (black and white) or run length encoded binary image data. Additionally, both the global and local feature extraction units can begin processing an image before the complete image is available.

### BRIEF DESCRIPTION OF THE DRAWINGS

FIG. 1 illustrates a flow chart diagram of a prior art scanning and decoding method.

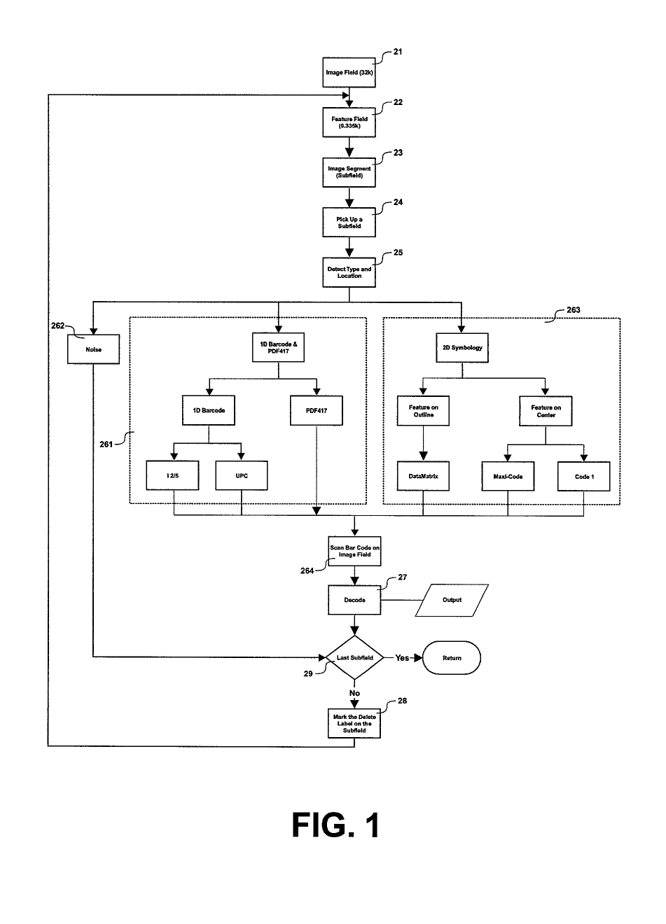

FIG. 2 illustrates a block diagram of an image capture decoding system utilizing global and local feature extraction, in accordance with one embodiment of the invention.

FIG. 3 illustrates an exemplary output of a binary image generator, in accordance with one embodiment of the invention.

FIG. 4 illustrates an exemplary down-sampled image created by the image down-sampling unit of FIG. 2, in accordance with one embodiment of the invention.

FIG. 5 illustrates a flow chart diagram of a global feature extraction algorithm in accordance with one embodiment of the invention.

FIG. 6 depicts an exemplary binary image overlaid with bounding box data produced by the global feature extraction algorithm of FIG. 5.

FIG. 7 shows a flow chart diagram depicting a local feature extraction algorithm in accordance with one embodiment of the invention.

FIG. 8 illustrates an exemplary image having a DataMatrix code located on a background pattern consisting of light and dark pixels.

FIG. 9 depicts a flow chart diagram of a global feature extraction algorithm for processing images exemplified by the image of FIG. 8, in accordance with one embodiment of the invention.

### DETAILED DESCRIPTION OF THE INVENTION

The invention is described in detail below with reference to the Figures, wherein like elements are referenced with like numerals throughout. In the various preferred embodiments described below, the invention provides a method and system for decoding 1- and 2-dimensional bar code symbols. Variations of the technique can be employed to read and decode optical characters, cursive script including signatures, and other optically encoded data. The disclosed system is able to process a captured high resolution image containing multiple bar codes and decode the symbols within 100 ms. The preferred embodiment includes a binary image generator, a global feature extraction unit and a local feature extraction unit. The binary image generator converts a scanned image into a binary image which means that multi-bit pixel values are assigned as either binary “black or white” values depending on whether the greyscale level of the respective pixel is above or below a predetermined or calculated threshold. This process is referred to herein as “binarization” or “binarizing.” In one embodiment, the invention utilizes a method and system for converting multi-bit image data into binary image data as described in co-pending and commonly-assigned U.S. application Ser. No. 09/268,222 entitled, “Optical Scanner and Image Reader for Reading Images and Decoding Optical Information Including One and Two Dimensional Symbologies At Variable Depth of Field.” Binary data images can be processed much more efficiently and rapidly than multi-bit grayscale or color images. Therefore, processing binary images significantly improves the speed of the code detection process. After the image is binarized, the global feature extraction unit analyzes the binary image and identifies areas of interest for further analysis, rejecting areas that do not have a desired shape. Thereafter, the local feature extraction unit analyzes the areas of interest and decodes the optical code symbols found within. In one embodiment, the local feature extraction unit is capable of decoding optical codes at any orientation, and is tolerant of damaged codes. Furthermore, both the global and local feature extraction units can begin processing portions of an image before the complete image is transferred from the sensor.

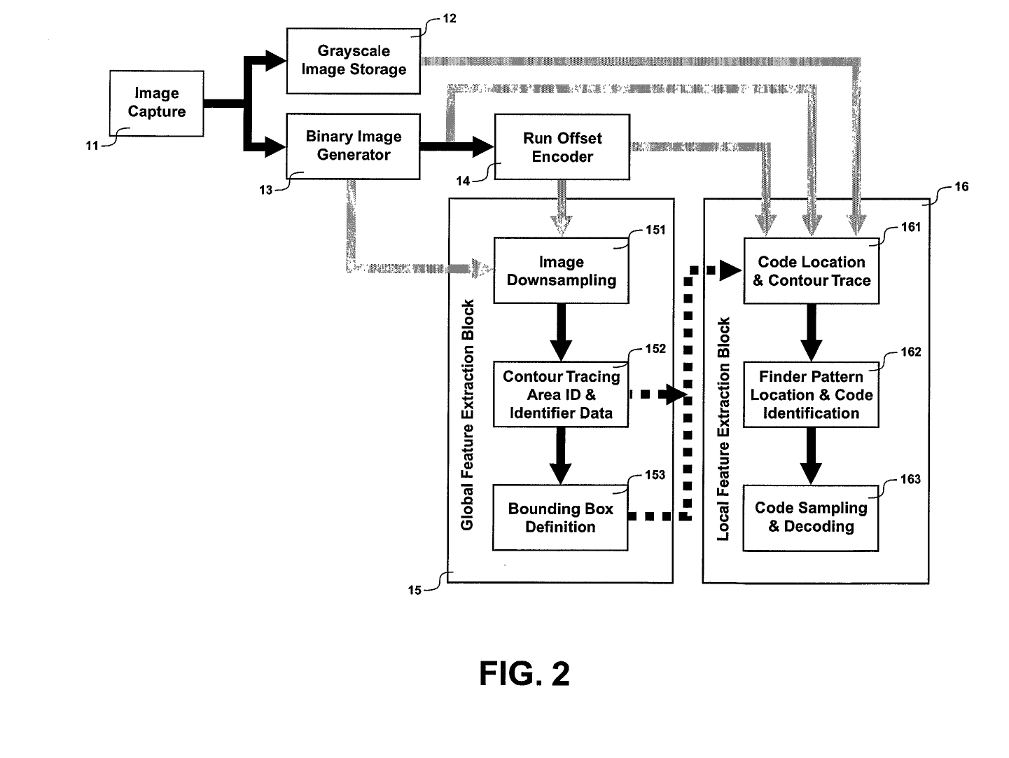

FIG. 2 illustrates a block diagram of an optical code reader system 10, in accordance with one embodiment of the invention. An image scene is captured electronically by an image capture unit 11. The image capture unit 11 may consist of a CMOS image sensor, CCD-type sensor or other spatial imaging device that is known in the art. One embodiment of an image capture device that may be used in accordance with the present invention is described in co-pending U.S. application Ser. No. 09/208,284, entitled “Imaging System and Method.” The image capture unit 11 captures the image and digitizes it to create a multi-bit representation of the image scene. In one embodiment, the image capture unit 11 generates multiple bits per image pixel as a grayscale representation of the image scene. In other embodiments, multiple-bit pixel data can represent pixel colors other than grayscale values. The digitized, grayscale or color, image data is then stored in a buffer 12. In addition to generating the digitized image data, the optical code reading system of the invention generates binary (black and white) image data using a binary image generator unit 13. As explained above, one embodiment of a method and system for generating the binary image is described in co-pending and commonly-assigned U.S. patent application Ser. No. 09/268,222. Since a binary image is a much more compact representation of the image scene, when compared to grayscale or color image data, it can be used for decoding the optical codes within the image in a much more efficient and rapid manner. In a further embodiment of the invention, the binary image data is further processed by a run offset encoder unit 14 to create ‘run-offset encoded’ data. As described in co-pending application Ser. No. 09/268,222, these steps can begin without requiring the entire image to be output from the sensor, thus reducing the latency between the time that the image is captured and the time that code extraction can begin.

Run-offset encoded data represents the image pixels by counting strings of consecutive, like-colored pixels and recording the current pixel color, the length of the string, and the starting location of the string as an offset relative to the start of the current row. A more detailed description of run-offset encoding can be found in U.S. application Ser. No. 09/268,222. As soon as the binary image generator unit 13 or run offset encoder unit 14 generates its data, the data is passed to the global feature extraction unit 15.

The global feature extraction unit 15 performs three operations on the binary or run-offset encoded data. The data is first down-sampled by a low-resolution image generation unit 151 to reduce the amount of data that needs to be processed, thereby further reducing processing time. In one embodiment, the down-sampling process measures the average value of N pixels within a predetermined area of the image and, depending on this average value, assigns one pixel value (in the case of binary data either black or white) for all N pixels in that region—in essence, treating the entire region of N pixels as a single pixel. Other down-sampling techniques which are well-known in the art may also be utilized in accordance with the invention. Next, a contour tracing and area identification unit 152 analyzes the processed, low-resolution image. The contour tracing and area identification unit 152 locates objects consisting of regions of connected pixels and can either mark or reject the objects as possible optical codes based on their shape. Numerous methods of contour tracing and identifying areas or objects of interest are known in the art. Any of these known methods may be utilized by the contour tracing and area identification unit 152 in accordance with the invention.

After areas or objects are identified as possibly containing optical codes, these areas are then analyzed by a bounding box definition unit 153 and enclosed within a bounded region or area defined by the bounding box definition unit 153. The corner points of the objects' bounding boxes are passed to the local feature extraction unit 16. In one embodiment of the invention, the shape of the objects determined by the contour tracing and area identification unit 152 is used to classify the optical code found within the object. For example, if the shape is a rectangle, the code within that region is most likely a 1-D bar code or PDF417 code. If the shape is a square, the code is most likely a 2-D code such as DataMatrix™, for example. This code classification data is then provided to the local feature extraction unit 16.

The local feature extraction unit 16 performs three basic operations on the binary or run-offset encoded image data, based on the bounding box information passed to it by the global feature extraction unit 15. The code location and contour tracing unit 161 is used to locate the optical code within its bounding box. Once located, the contour of the optical code is traced and the corners of the code identified. The corners give an indication of the orientation of the code with respect to the captured image. The finder pattern location and code identification unit 162 is used to identify the start point of the optical code and determine the type of code used. Once this data is captured, the orientation and scan direction of the code is known. Next, the code sampling and decoding unit 163 samples the image along the optical code's required scan path to create a representation of the optical code suitable for decoding. The code sampling and decoding unit 163 then chooses a sampling method that maximizes the decode success of the optical code, allowing for a high tolerance of damaged code symbols. As used herein the term “unit” refers to either hardware (e.g., a circuit), software (e.g., an computer algorithm for processing data), firmware (e.g., a FPGA), or any combination of these implementations.

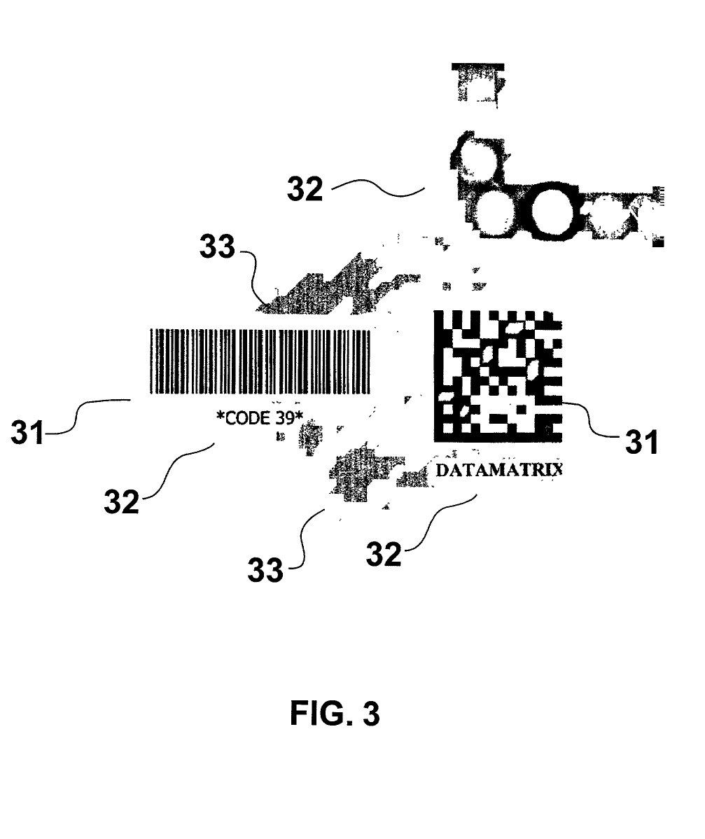

FIG. 3 illustrates a typical image scene captured by the optical scanner after binarization by the binary image generator unit 13 (FIG. 2). The image contains a number of different bar codes 31 and non-bar code data 32. This typical scene includes shaded regions within the binary image 33 that may be caused by variations in illumination. In one embodiment, this binarized image is sent to the global feature extraction unit 15 of FIG. 2. In another embodiment, this binary image data may additionally, or alternatively, be converted into run-offset-encoded data which is then sent to the global feature extraction unit 15 of FIG. 2. By compressing the scanned image into a binary data format, or run-offset-encoded format, prior to processing by the global extraction unit 15, the invention provides significant advantages in processing speed and efficiency.

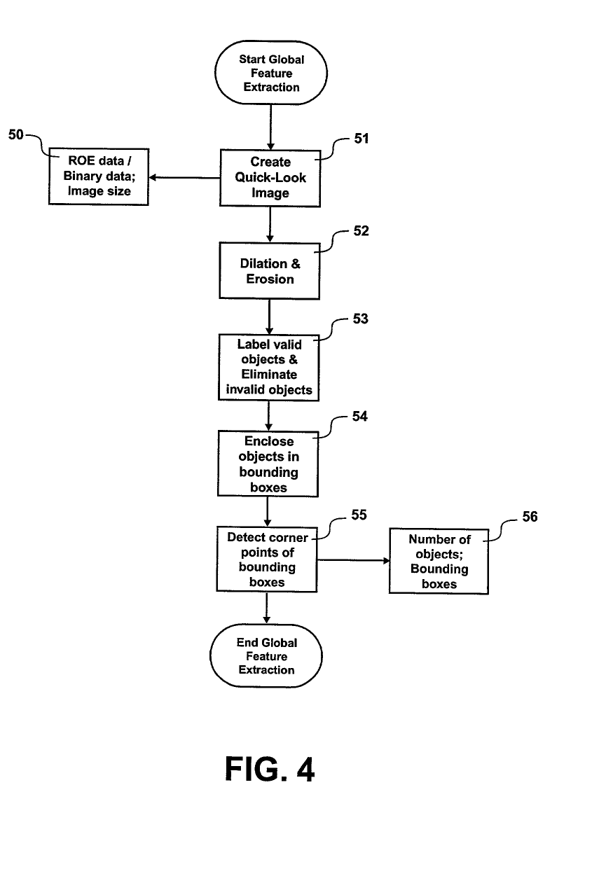

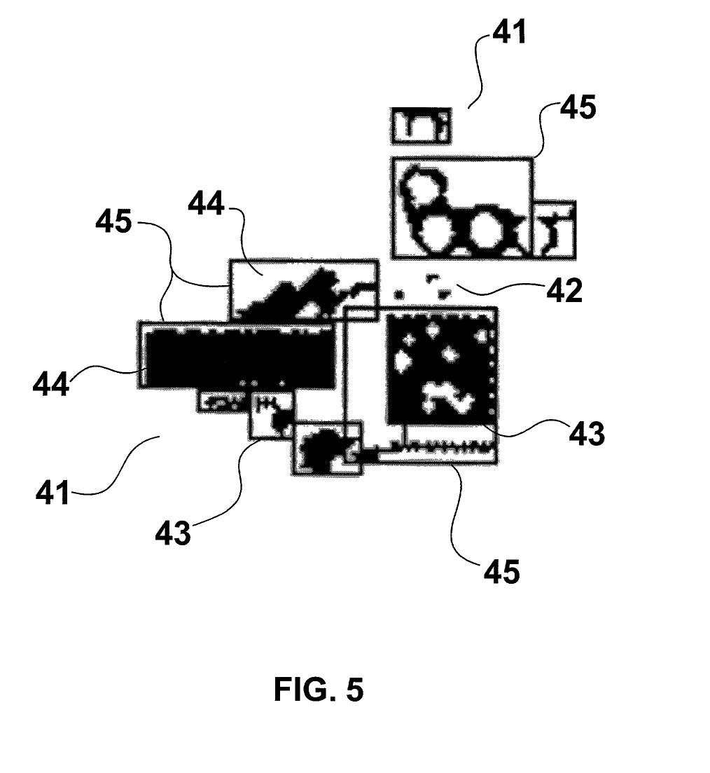

FIG. 4 illustrates a flow chart diagram of a method of global feature extraction, in accordance with one embodiment of the invention. The process begins at step 50 where image data, in the form of a binary bitmap or run-offset encoded data, is input to the image down sampling unit 151 of the global feature extraction unit 15 of FIG. 2. Next, at step 51, a “quick look” or low-resolution image is created. An example of a “quick look” image based on the scene of FIG. 3 is illustrated in FIG. 5. In one embodiment of the invention, the low-resolution image is created by sampling 1 out of every 10 columns and 1 out of every 10 rows of the original image for a total reduction of 100 times. In another embodiment, the image is down-sampled by dividing the full-resolution image into small blocks of pixels and computing an average pixel value for each block. The average value can then be compared to a specified threshold value, to convert it to a binary, black or white value. Other pixel reduction ratios may be more suitable depending on the size of the original image or the processing speed of the global feature extraction unit 15. This results in a compact image that permits rapid processing while retaining enough image data to identify possible optical code areas. In a preferred embodiment, both global and local feature extraction processes can commence as soon as a single row of image data is ready; it is not necessary to wait until the entire image scene has been output by the image capture unit 11.

Depending on the content of the original image, the low-resolution image may need further enhancement before decoding can continue. For example, the down-sampling operation may cause optical codes within the image to contain white space. The global feature extraction unit 15 requires that the optical code regions consist of relatively uniform blocks of dark pixels. To ensure this, at step 52, a dilation and erosion operation is carried out on the low-resolution image. In the preferred embodiment, the dilation step simply involves adding a black pixel above, below, to the left of, and to the right of each black pixel in the image. The erosion step can then be a simple subtraction of one black pixel from the edge of each region of black pixels. Other dilation and erosion operations may be better suited to a particular application, and fall within the scope of the invention. Next, at step 53, regions of black pixels that may contain optical codes are located and labeled. This is accomplished by scanning the low-resolution image until a black pixel region is located and, thereafter, tracing the contour of the black pixel region. In one embodiment, contour tracing is done using a 4-way chain code. Chain code algorithms are well known tools used for tracing the contour of connected regions of pixels, and are described in detail in Pavlidis, “Algorithms for Graphics and Image Processing,” for example. The contour of each black pixel region can be examined in turn and evaluated based on size and shape. If the size or shape of the region does not match the expected size and shape of a block as defined by a user or programmer, the area can be rejected as a possible region containing code. The contour of each black pixel region can also be used to detect the class of bar code found within. For example, as shown in FIG. 5, square regions 43, for example, are most likely 2D bar codes such as Data Matrix or MaxiCode. Rectangular regions 44 may be either 1D bar codes or PDF417 codes. At step 54, each remaining area or object which was not previously rejected is then enclosed in a bounding box 45 (FIG. 5). The bounding box 45 is defined as the minimum and maximum row and column numbers of the binary image that completely enclose a black pixel region. At step 55, the coordinates of the bounding box corners are detected (e.g., calculated) by a software algorithm and stored in a memory of the optical code reader of the invention. Such software algorithms are well-known in the art. In one embodiment, at step 56, the software algorithm also counts the number of remaining objects and bounding boxes enclosing the objects. The location of each bounding box and the class of optical code found within is passed as control information to the local feature extraction unit 16 (FIG. 2).

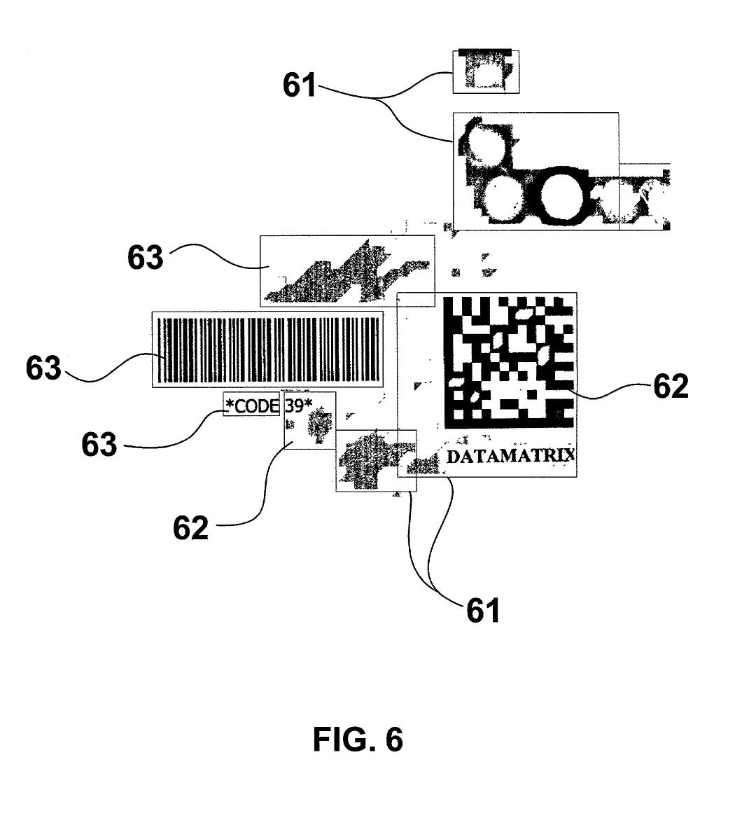

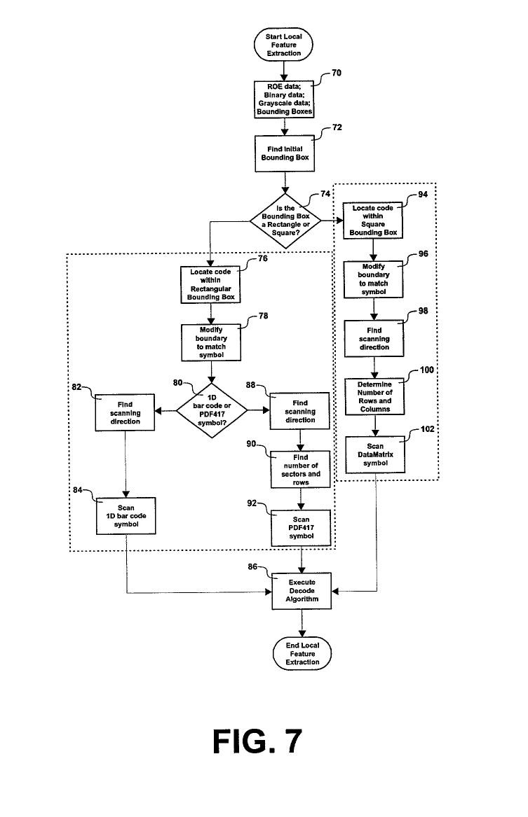

As soon as the first bounding box location data is available, local feature extraction unit 16 can begin processing the binary image bitmap or run-offset encoded data. Other embodiments allow the local feature extraction unit 16 to process multi-bit image data instead of binary or run-offset encoded data. An illustration of the typical image scene overlaid with bounding box data is shown in FIG. 6. Bounding boxes defined by the global feature extraction unit 15 are overlaid on the full-resolution image 61. Areas of interest are shown as either square areas 62 or rectangular areas 63. A flow chart diagram of one embodiment of the local feature extraction algorithm is shown in FIG. 7. For purposes of explanation, FIG. 7 includes the local feature extraction steps for three optical codes: Data Matrix, 1-D code (e.g., “Code 39”) and PDF417. Similar processing steps would be followed to decode any other types of optical codes, as is evident to those skilled in the art. The local feature extraction process commences at step 70 where bounding box data and run-offset encoded data, binary data and/or grayscale data are input to the local feature extraction unit 16 (FIG. 2). At step 72, a first bounding box is identified to be processed. Next, at step 74, the local feature extraction algorithm determines the type of code, if any, contained within the bounding box, by detecting whether the shape of the bounding box is rectangular or square. As explained above, if the bounding box shape is rectangular, this means that the code is most like a 1-D bar code or PDF417 type code. Whereas if the bounding box shape is a square, this indicates a 2-D code such as Data Matrix. As is known in the industry, however, PDF417 codes can sometimes have a square shape. Therefore, in one embodiment, the invention contemplates that a PDF417 code may be present within either a rectangular or square bounding box region.

If a rectangular bounding box shape is detected, the algorithm proceeds to step 76 wherein the actual rectangular code is more precisely located within its bounding box region. This step involves starting at the left edge of the bounding box and scanning for black pixels on a line towards the center of the bounding box. Once a black pixel is located, a chain code algorithm is executed to trace the contour of the optical code. The chain code algorithm used at this step is optimized for speed and creates a coarse outline of the bar code. The approximate corner points of the optical code can be detected using the chain code data. At step 78, the approximate corner points determined by the chain code are then corrected to match the true corner points of the bar code. Next at step 80, the algorithm determines whether the code is a 1D optical code or a PDF417 code. To do this, five test scan lines are used to differentiate between 1D optical codes and PDF417. If it is determined that the code is a 1D optical code, at step 82, the results of the test scan are used to determine the scan direction based on the start- and stop-codes detected for the 1D optical code. At step 84, the 1D code is then scanned by a number of closely spaced scan lines and the results averaged to obtain a ‘clean’ code suitable for decoding. Finally, at step 86, the scanned code is decoded using a 1D decoding algorithm.

If at step 80, it is determined that the code is a PDF417 code, the local feature extraction algorithm moves to step 88, where the results of the test scan of step 80 are used to determine the scan direction based on the start- and stop-codes detected for the PDF417 optical code. To decode a PDF417 code, the number of sectors and rows must first be determined. Therefore, at step 90, a number of closely spaced test scan lines are analyzed to count sectors and rows. In the case of 1D codes, this step is not necessary and the results of the test scan are used to select a scan line location that is substantially free of defects. At step 92, the symbol is then scanned by a number of closely spaced scan lines and the results averaged to obtain a ‘clean’ code suitable for decoding. The PDF417 code is then decoded at step 86 by a PDF417 decoding algorithm.

If at step 74 it is determined that the shape of the bounding box region is square, the local feature extraction algorithm proceeds to step 94, wherein the location of the actual square symbol or code is found by scanning inside the bounding box from edge to center until a black pixel is located. As explained above with respect to the rectangular code, a chain code algorithm traces the contour of the code, and the corners of the contour are identified. At step 96, the boundary points of the square code are modified by adjusting the corner points to match the scanned image. Next, at step 98, the orientation of the code is identified. To determine the code direction, the bounding box is again scanned using a more precise chain code in order to locate the optical code finder pattern. In the case of a Data Matrix code, the finder pattern is the solid L-shaped border found at the left, bottom edge of the code and the dashed L-shape on the upper, right edge of the code. Either can be located by scanning from one edge of the bounding box towards the center. Once a dark pixel is located, the chain code traces the outline of any connected dark pixels. If the contour does not match a finder pattern, a new scan direction is chosen. If all four scan directions (left edge to center, top edge to center, right edge to center, and bottom edge to center) do not yield the expected finder pattern, the code is not a Data Matrix code. Once a finder pattern is identified, at step 100, the number of rows and columns found in the Data Matrix is determined by scanning the top and right edges of the code. Next, at step 102, the 2D code is scanned and, thereafter, at step 86, an appropriate decoding algorithm is executed to process the scanned data.

Other types of 2D bar codes that have a centrally located finder pattern, such as Maxi Code and Aztec Code, can be similarly identified by scanning from the center of the bounding box toward the edges. Upon encountering a dark pixel, the more precise chain code will trace the boundary of the connected region. The ‘bulls-eye’ pattern of concentric circles or squares can be located and the code size and orientation can then be extracted. Once the size, orientation, and density of the 2D code are known, the grid points can be sampled to determine if they are white or black. To ensure accuracy, each grid point is sampled a number of times and the results averaged. This creates a ‘clean’ optical code suitable for decoding.

The start and stop codes of 1-D bar codes and PDF417 codes, the “L”-shaped finder pattern of 2-D Data Matrix, and any other type of code pattern which can indicate an orientation and/or scanning direction of an optical code is collectively referred to herein as a “finder pattern” or an “orientation pattern.”

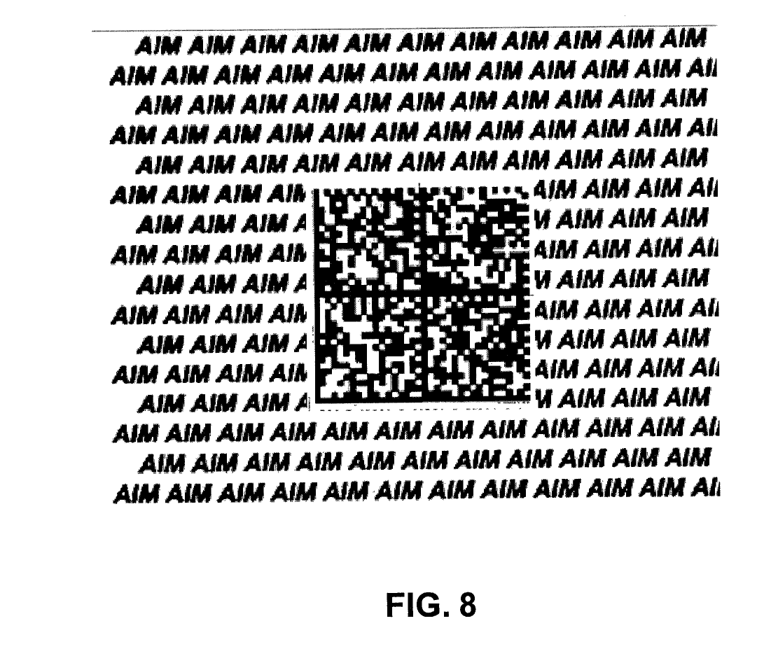

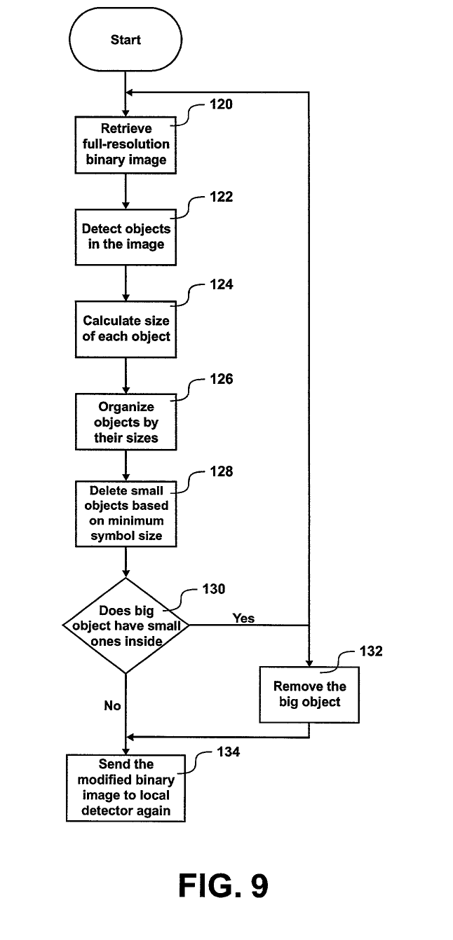

In some cases, an optical code may be printed on or embedded within a background pattern or image having many light and dark areas. An example of an optical code printed on a background pattern is shown in FIG. 8. In this situation, the low-resolution image generated by the image down-sampling unit 151 (FIG. 2) may consist of entirely dark pixels. The processing of this low-resolution image first proceeds as described above to see if the image simply contains a very large optical code. If the bounding box exceeds a certain percentage of the total image area, and the processing of this image does not produce a successful decode, the Global Feature Extraction Unit switches to a second mode of operation which is illustrated by the flow chart diagram of FIG. 9. In this mode, the down-sampling unit 151 is bypassed and the remaining steps of the global feature extraction unit 15 are repeated on the full-resolution, binary or run-offset-encoded image. This second mode of operation begins at step 120 by retrieving the full-resolution binary or run-offset encoded image that was previously stored in a memory of the optical scanner. Next, at step 122, the full-resolution image is provided to the contour tracing and area identification unit 152 (FIG. 2) to identify objects consisting of dark pixel regions and create bounding boxes surrounding each identified object or region. At step 124, the size of each objects' bounding box is calculated. Next, at step 126, the objects are organized and sorted by size. At step 128, objects that are smaller than a specified minimum required size are rejected as potential objects containing code (e.g., the bounding box surrounding the object is removed from the image). Next at step 130, the remaining objects are further processed to determine if they contain smaller objects within them. If an object is large relative to the image size and contains smaller objects inside it, it cannot be an optical code and, therefore, its bounding box is also rejected. If such an object exists in the full-resolution image, at step 132, the bounding box surrounding the large object is also rejected. However, the smaller objects found within the larger object are not rejected at step 132. In one embodiment, these smaller objects are processed in accordance with steps 128 and 130 described above. At step 134, any remaining objects and their bounding box corner points are then passed to the local feature extraction unit 16 (FIG. 2).

As would be apparent to those of ordinary skill in the art, many variations and modifications to the above-described system fall within the spirit and scope of the invention. For example, the global feature extraction unit 15 (FIG. 2) may process a number of different image data formats. Extracted data can also be used to track moving objects in machine vision applications or as a deterministic element for compressing only a selected target within the image field. The preferred embodiment describes the use of binary image data or run-offset encoded image data in the global feature extraction unit. Other embodiments of the invention allow global feature extraction based on multi-bit image data, including grayscale or color images. If multi-bit image data is used during global feature extraction, the image down sampling unit 151 (FIG. 2) can be altered to generate binary image data based on an initial threshold value wherein a grayscale pixel, for example, is compared against the threshold value and assigned a value of ‘white’ or ‘black’ based on the comparison. All other global feature extraction steps would continue as described above. Another possible implementation is to generate a low-resolution multi-bit image and adjust the contour tracing and area identification unit 152 (FIG. 2) to compensate.

Similarly, in various embodiments, the local feature extraction unit 16 (FIG. 2) may be modified to support the processing of multi-bit image data. For example, one embodiment of the invention may alter the local feature processing algorithm of FIG. 7 to load and process the multi-bit image data if the symbol cannot be decoded using the binary or run-offset encoded image data.

It is readily apparent to those of ordinary skill that the features of the invention can also be applied to other applications, such as biometrics. In this field, the optical code may consist of a fingerprint, retinal pattern or facial features. The high tolerance for damaged codes and high-speed operation of the invention are especially useful to applications in this field. As another example, the invention may also be utilized to achieve the efficient transmission of video or dynamic scenes captured as digital images (e.g., a DVD movie). Many moving image scenes contain areas that do not change from frame to frame, such as the background of a scene. In order to allow a full-resolution moving image to be carried on a bandwidth-limited channel, the encoder can transmit only the areas of the image that are changing. The global feature extraction unit can be used to detect areas of movement within an image scene, and enclose them in a bounding box. Thereafter, the only areas of the image that need to be transmitted are those that are enclosed in bounding boxes.

Therefore, it is understood that the foregoing description of preferred embodiments illustrate just some of the possibilities for practicing the present invention. Many other embodiments and modifications which would be obvious to one of ordinary skill in the art are possible within the spirit of the invention. Accordingly, the scope of the invention is not limited to the foregoing descriptions of particular embodiments, which are exemplary only, but instead is commensurate with the scope of the appended claims together with their full range of equivalents.

What is claimed is:

1. A method of identifying and decoding information contained in an image, comprising:
capturing said image with an imaging device;
generating digital image data representative of at least a portion of the captured image;
storing the digital image data in a memory;
down-sampling the digital image data to generate low-resolution image data;
processing the low-resolution image data to identify a region of interest that potentially contains a code;
wherein if no region of interest is identified by said step of processing the low-resolution image data, processing said stored digital image data to identify said region of interest;
identifying a code within the region of interest; and
decoding the code.

2. The method of claim 1 wherein said digital image data comprises a binary bit map of at least a portion of said captured image.

3. The method of claim 1 wherein said digital image data comprises run-offset-encoded data representative of at least a portion of said captured image.

4. The method of claim 1 wherein said step of processing said low-resolution image data comprises:
identifying within a low-resolution image, represented by said low-resolution image data, an area consisting of substantially dark pixels connected to one another;
tracing the contour of said area, wherein if the dimensions of the area meets specified criteria, said area is identified as said region of interest that potentially contains said code; and
enclosing the area within a bounding box.

5. The method of claim 4 wherein said step of identifying a code comprises:
locating said code within said bounding box;
identifying a code type for said code contained within said bounding box; and
determining an orientation of the code.

6. The method of claim 5 wherein said step of locating said code within said bounding box, comprises:
overlaying said bounding box on a full-resolution image represented by said digital image data; and
tracing a contour of said code in the full-resolution image.

7. The method of claim 5 wherein said step of determining said code type comprises determining a shape of said bounding box, wherein if said bounding box is rectangular in shape, said code is determined to be a 1-D bar code or PDF417 code; and wherein if said bounding box is square in shape, said code is determined to be a 2-D code.

8. The method of claim 7 wherein said step of identifying said code type further comprises scanning said code within said bounding box to identify a finder pattern, and wherein said step of determining an orientation of the code comprises determining an orientation of said finder pattern.

9. The method of claim 1 wherein said step of processing said stored digital image data comprises:
identifying within a higher-resolution image, represented by said stored digital image data, an area consisting of substantially dark pixels connected to one another;
tracing the contour of said area, wherein if the shape of the area meets specified criteria, said area is identified as said region of interest that potentially contains said code; and
enclosing the area within a bounding box.

10. The method of claim 9 further comprising:
calculating the size of said bounding box enclosing said area;
determining if said bounding box is smaller than a specified minimum size, wherein if the bounding box is smaller than the specified minimum size, the area is rejected as potentially containing said code; and
if said bounding box is not smaller than the specified minimum size, determining if said bounding box contains smaller objects within the bounding box, wherein if the bounding box contains smaller objects within, the bounding box is removed from said high-resolution image.

11. The method of claim 1 wherein said step of identifying a code within an identified region of interest commences before the entire image is captured by said step of capturing said image.

12. The method of claim 1 wherein said step of down-sampling said digital image data commences before the entire image is captured by said step of capturing said image.

13. An optical imaging device comprising:
an image capture unit for capturing an image and generating a signal representative of at least a portion of the captured image;
a binary image generator unit for converting the signal into binary image data;
a global feature extraction unit for down-sampling the binary image data to generate low-resolution image data and thereafter processing the low-resolution image data to identify a region of interest that potentially contains an optical code, wherein if no region of interest is identified, the global feature extraction unit processes said binary image data to identify said region of interest; and
a local feature extraction unit for receiving coordinate data pertaining to the region of interest from the global feature extraction unit, locating a code within the region of interest, identifying the code, and decoding the code.

14. The device of claim 13 wherein said global feature extraction unit begins down-sampling said binary image data before the entire image is transferred from said image capture unit to said binary image generator unit.

15. The device of claim 14 wherein said local feature extraction unit commences said step of locating said code within said region of interest before the entire image is converted into binary image data by said binary image generator unit.

16. The device of claim 13 wherein said global feature extraction unit comprises:
a image down-sampling unit for receiving said binary image data and converting said binary image data into low-resolution image data;
a contour tracing and area identification unit for processing said low-resolution image data or, alternatively, said binary image data, to identify a region containing dark pixels connected together, wherein said identified region is designated as said region of interest; and
a bounding box definition unit for enclosing the identified region within a bounding box.

17. The device of claim 16 wherein said local feature extraction unit comprises:
a code location and contour tracing unit for locating an optical code within said bounding box region;
a finder pattern and code identification unit for identifying a code type for the optical code within the bounding box region and locating a finder pattern of the optical code; and
a code sampling and decoding unit for sampling an image within the bounding box region so as to create a representation of the optical code for decoding.

18. The device of claim 16 wherein said contour tracing and area identification unit further classifies said region of interest based on its shape, wherein if the shape is rectangular, the region of interest is designated as potentially containing a 1-D bar code or PDF417 code, and if the shape is square, the region of interest is designated as potentially containing a 2-D optical code.
